(19) United States
(12) Patent Application Publication
(10) Pub. No.: US 2025/0042730 A1
(43) Pub. Date: Feb. 6, 2025

(54) SYSTEMS AND TECHNIQUES FOR ELECTRICAL HEATING FOR HYDROCARBON PYROLYSIS

(71) Applicant: Honeywell International Inc., Charlotte, NC (US)

(72) Inventors: Mehrad Mehr, Morristown, NJ (US); Robert Mantz, Clifton, NJ (US); Bahram Jadidian, Watchung, NJ (US)

(21) Appl. No.: 18/362,864

(22) Filed: Jul. 31, 2023

(51) Int. Cl. C01B 3/24; B01J 6/00

(52) U.S. Cl. CPC C01B 3/24; B01J 6/008; C01B 2203/0272; C01B 2203/085; C01B 2203/1241

(57) ABSTRACT

A pyrolysis system for generating hydrogen gas by hydrocarbon pyrolysis may include a pyrolysis furnace and a heating system. The pyrolysis furnace may include a chamber defining a furnace interior. The chamber may include a thermal barrier. The heating system may include a heating element coupled to an electrical lead at a lead junction. The lead junction may be within the furnace interior. The electrical lead may include a refractory material. A maximum cross-sectional area of the electrical lead may be less than a minimum cross-sectional Joule area of the heating element. A technique for assembling a system configured to generate hydrogen gas by hydrocarbon pyrolysis may include positioning the heating element within the furnace interior of the pyrolysis furnace, and coupling the electrical lead to the heating element at the lead junction within the furnace interior.

### STATEMENT REGARDING FEDERALLY SPONSORED RESEARCH OR DEVELOPMENT

This invention was made with Government support under Government Contract No. 80MSFC21CA010 awarded by NASA. The Government has certain rights in the invention.

### TECHNICAL FIELD

The present disclosure relates to heating systems and techniques for hydrocarbon pyrolysis, and to electrical heating for hydrocarbon pyrolysis.

### BACKGROUND

An environmental control system (ECS) of a structure, such as a building or vehicle, may remove carbon dioxide expelled by occupants of an environment, such as a room or cabin, to maintain comfort and safety. In some instances, the carbon dioxide may be absorbed from the environment by a liquid sorbent and desorbed from the liquid sorbent for discharge from the structure. However, for an atmosphere limited structure, such as a spacecraft or submarine, such discharge of carbon dioxide may waste oxygen from the carbon dioxide that may otherwise be recovered. To extract oxygen from the carbon dioxide, the ECS may react the carbon dioxide with hydrogen gas to form methane through a Sabatier reaction. The ECS may produce at least a portion of this hydrogen gas by pyrolyzing methane, which may generate solid carbon as a byproduct. Pyrolysis may be achieved using a heating element.

### SUMMARY

In general, the present disclosure describes systems and techniques for hydrocarbon pyrolysis, and electrical heating for hydrocarbon pyrolysis. Certain pyrolysis furnaces may include a heating element extending through a thermal barrier, with electrical leads coupled to the heating element at lead joints exterior to the thermal barrier. In systems and techniques according to the present disclosure, electrical leads may extend through the thermal barrier into an interior of the furnace, and be coupled to a heating element at lead joints interior to the thermal barrier.

The electrical leads may have a maximum cross-sectional area that is smaller than that a minimum cross-sectional Joule area of the heating element (for example, a minimum cross-sectional area of a portion of the heating element that generates Joule heating). The relatively lower cross-sectional area of the electrical leads reduces heat lost from the furnace to the exterior of the furnace through the lead joints or the electrical leads. The present disclosure further describes clamps configured to couple a heating element to electrical leads, for example, within an interior of the furnace.

Clamps according to the present disclosure may promote retention of lead joints even at elevated temperatures, and resist degradation and loose connections of the heating element. For example, a heating element may include a clamp at each respective end of the heating element, the clamp including an expansion slot configured to accommodate or relieve thermal stresses, thus promoting the retention of electrical contact between the heating element and electrical leads at elevated temperatures.

In some examples, the present disclosure describes a pyrolysis system for generating hydrogen gas by hydrocarbon pyrolysis. The pyrolysis system may include a pyrolysis furnace and a heating system. The pyrolysis furnace may include a chamber defining a furnace interior. The chamber may include a thermal barrier. The heating system may include a heating element coupled to an electrical lead at a lead junction. The lead junction may be within the furnace interior. The electrical lead may include a refractory material. A maximum cross-sectional area of the electrical lead may be less than a minimum cross-sectional Joule area of the heating element.

In some examples, the present disclosure describes a technique for assembling a system configured to generate hydrogen gas by hydrocarbon pyrolysis. The technique may include positioning a heating element within a furnace interior of a pyrolysis furnace including a chamber including a thermal barrier. The technique may further include coupling an electrical lead to the heating element at a lead junction within the furnace interior. The electrical lead may include a refractory material. A maximum cross-sectional area of the electrical lead may be less than a minimum cross-sectional Joule area of the heating element.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1 is a partial side view of a pyrolysis system including a pyrolysis furnace, a heating element, and a lead junction in an exterior of the pyrolysis furnace.

FIG. 2 is a partial side view of a pyrolysis system including a pyrolysis furnace, a heating element, and a lead junction in an interior of the pyrolysis furnace.

FIG. 3 is a partial cross-sectional view of a pyrolysis system including a pyrolysis furnace, a heating element, a lead junction in an interior of the pyrolysis furnace, and a carbon deposition substrate.

FIG. 4A is a perspective view of a clamp for coupling a heating element to an electrical lead for a pyrolysis system.

FIG. 4B is a front view of the clamp of FIG. 4A.

FIG. 4C is a side view of the clamp of FIG. 4A.

FIG. 5A is a perspective view of a clamp assembly including nuts coupled to sides of the clamp of FIG. 4A in an uncompressed configuration.

FIG. 5B is a perspective view of the clamp assembly of FIG. 5A in a compressed configuration.

FIG. 6 is a flowchart representing a technique for forming a pyrolysis system configured to generate hydrogen gas by hydrocarbon pyrolysis.

### DETAILED DESCRIPTION

In general, the disclosure describes systems and techniques for generating hydrogen gas, for example, by hydrocarbon pyrolysis. Systems and techniques according to the present disclosure use electrical heating, for example, via a heating element coupled to an electrical lead.

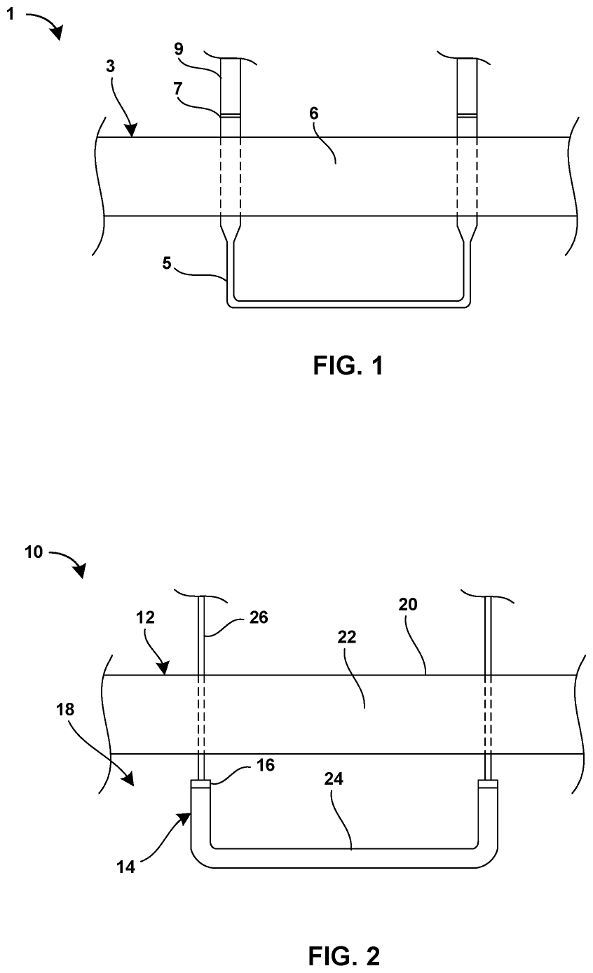

FIG. 1 is a partial side view of a pyrolysis system 1 including a pyrolysis furnace 3, a heating element 5, and a lead junction 7 in an exterior of pyrolysis furnace 3. Heating element 5 is coupled to an electrical lead 9 at lead junction 7 (and to another electrical lead at another lead junction). Lead junction 7 is positioned in the exterior of pyrolysis furnace 3 to shield the lead junction 7 from elevated temperatures in an interior pyrolysis furnace 3, and to provide a transition to a different material, for example, to that of electrical lead 9.

As shown in FIG. 1, the end portions of heating element 5 extend through a thermal barrier 6 (or a wall) of pyrolysis furnace 3 into an exterior of pyrolysis furnace 3. The end portions of heating element 5 have a maximum cross-sectional area (or maximum diameter) greater than that of the major length of heating element 5 in an interior of pyrolysis furnace 3. In some examples, the maximum cross-sectional area of heating element 5 is the same as, or less than, the maximum cross-sectional area of that of the major length of heating element 5. Electrical lead 9 may have a greater cross-sectional area than that of a major length of heating element 5 to reduce Joule heating in an exterior of the furnace or outside a hot zone of the furnace.

While the configuration of FIG. 1 may have certain advantages such as ease of construction, reduced Joule heating outside the hot zone, and greater tolerances to lead joint construction, the configuration of FIG. 1 may result in significant heat loss. The heat loss may arise from the relatively high cross-sectional area of the heating element extending through the thermal barrier, which may provide a substantial thermal path for heat to be dissipated from an interior of pyrolysis furnace 3 to exterior of pyrolysis furnace 3.

FIG. 2 is a partial side view of a pyrolysis system 10 including a pyrolysis furnace 12, a heating system 14, and a lead junction 16 in a furnace interior 18 of pyrolysis furnace 12.

Pyrolysis furnace 12 may include a chamber 20 defining furnace interior 18. Chamber 20 may include a thermal barrier 22. Thermal barrier 22 may include at least one layer of insulating material. Heating system 14 may include a heating element 24 coupled to an electrical lead 26 at lead junction 16. Lead junction 16 may include a mechanical joint, a clamp, a weld, or a braze.

Lead junction 16 may include one or more of a nut, a threaded shaft, a bolt, or a press-fit connection configured to provide a conductive path between electrical lead 26 and heating element 24. In some examples, an end of heating element 24 is coupled to electrical lead 26 at lead junction 16. In some examples, such as system 10 illustrated in FIG. 2, electrical lead 26 is a first electrical lead, lead junction 16 is a first lead junction, and system 10 further includes a second electrical lead coupled to heating element 24 at a second lead junction. In some such examples, the first lead junction couples a first end (or a first portion) of heating element 24, and the second lead junction couples a second end (or a second portion) of heating element 24.

Heating element 24 includes a resistive metal, alloy, ceramic, glass, carbon, graphite, or any other suitable resistive material, or combinations thereof. In some examples, heating element 24 includes a carbon-carbon composite, silicon carbide, or graphite. Heating element 24 is configured to generate heat in response to passage of electrical current via electrical lead 26 through heating element 24. System 10 may include two lead junctions coupling a respective electrical lead to a respective portion of heating element 24, for example, a respective end portion of heating element 24.

Heating element 24 may have a substantially uniform cross-sectional area or diameter between lead junctions, or otherwise along a resistive path of heating element 24. In some examples, end portions of heating element 24 may have a relatively lower cross-sectional area or diameter than a major central length between end portions of heating element 24. In some examples, heating element 24 may taper or continuously reduce in cross-sectional area or diameter from the major central length to the end portions. In some such examples a cross-sectional diameter of heating element 24 at or adjacent lead junction 16 may be substantially the same as a cross-sectional diameter of electrical lead 26 at or adjacent lead junction 16.

Heating element 24 may have any suitable shape along a major length of heating element 24. For example, heating element 24 may include one or more segments that are rod-shaped or cylindrical. Heating element 24 may include one or more bends or undulations. In some examples, heating element 24 extends along a C-shaped, D-shaped, U-shaped, V-shaped, zig-zag shaped, or smoothly undulating path. Heating element 24 may define any suitable similar or different cross-section in one or more segments, for example, circular, ellipsoidal, oblong, elongated, polygonal, square, rectangular, or hexagonal.

Electrical lead 26 includes a refractory material. For example, the refractory material may include one or more materials configured to substantially maintain structural integrity during temperatures associated with hydrocarbon pyrolysis. In some examples, electrical lead 26 includes a metal or an alloy. For example, electrical lead 26 may include molybdenum, tungsten, a superalloy, or titanium-zirconium-molybdenum (TZM) alloy. In some examples, electrical lead 26 includes a high-conductivity refractory material. For example, the conductivity of electrical lead 26 may be in a range having an order of magnitude of 10⁷ S/m (or a resistivity of electrical lead 26 may be lower than an order of magnitude of 10⁻⁷ Ωm, for example, 10⁻⁶ Ωm, or 10⁻¹ Ωm), and the high-conductivity refractory material may include one or more of tungsten, platinum, rhodium, molybdenum, or TZM. In some examples, the refractory material has an electrical conductivity that is at least 200%, or at least 500%, or at least 10 times, or at least 100 times, or at least 1000 times of an electrical conductivity of heating element 24.

A maximum cross-sectional area of electrical lead 26 may be less than a minimum cross-sectional Joule area of heating element 24. For example, the Joule area of heating element 24 is an area of a portion of heating element 24 that generates Joule heating. In some examples, heating element 24 may include a second portion that does not substantially generate Joule heating, or otherwise does not generate heat within an interior of pyrolysis furnace 12. The second portion may have a cross-sectional area that differs from the minimum cross-sectional Joule area of heating element 24. In some examples, a cross-sectional area of a portion of electrical lead 26 coupled to heating element 24 may be less than a minimum cross-sectional area of an entirety of heating element 24. In some examples, the maximum cross-sectional area of electrical lead 26 is 10% or less, or 1% or less, or 0.1% or less, of the minimum cross-sectional area of an entirety of heating element 24, or of the minimum cross-sectional Joule area of heating element 24.

Because electrical lead 26 extends within furnace interior 18, and heating element 14 and lead junction 16 positioned within furnace interior 18, system 10 may exhibit a relatively lower heat loss through one or both of a lead junction or an electrical lead positioned in an exterior of a pyrolysis furnace, such as compared to a heating element that extends through a thermal barrier to a furnace exterior (for example, as described with reference to FIG. 1).

Electrical lead 26 may have a lower maximum cross-sectional area compared to thickened portions of electrical leads in systems in which a lead junction is positioned in an exterior of a pyrolysis furnace (for example, as described with reference to FIG. 1). Thus, electrical lead 26 may present a relatively narrower thermal conductive path for heat to be lost from furnace interior 18 to an exterior of furnace 12, and thus suffer from a lower heat loss through electrical lead 26 compared to systems in which an electrical lead has a relatively higher cross-sectional area or diameter.

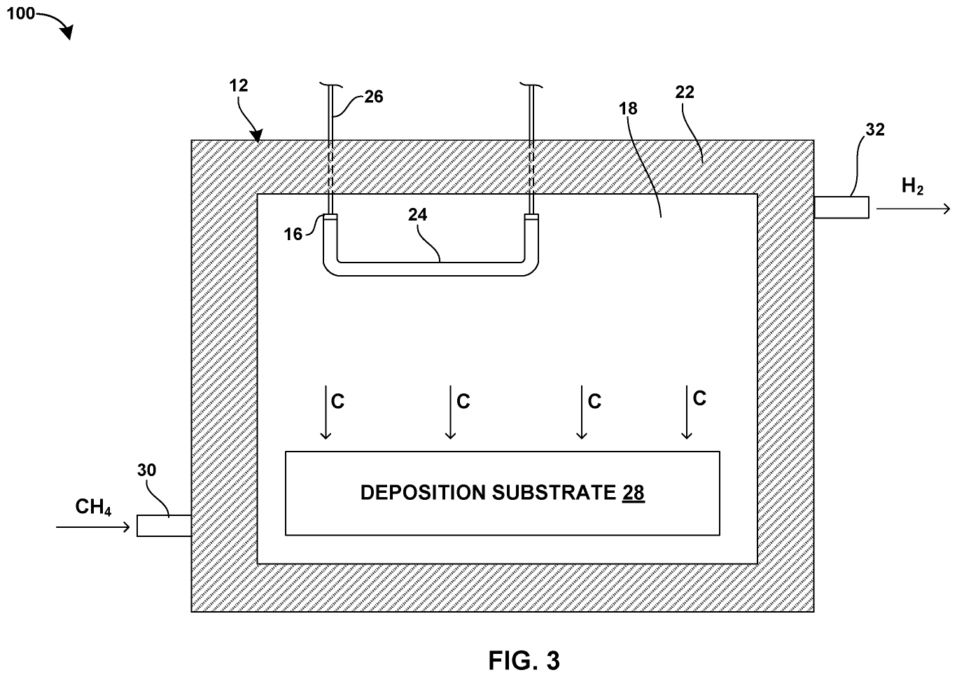

Heating element 24 may heat interior 18 of furnace 12 so that a hydrocarbon, such as methane, is pyrolyzed to generate hydrogen, as described with reference to FIG. 3.

FIG. 3 is a partial cross-sectional view of a pyrolysis system 100 including pyrolysis furnace 12, heating element 24, lead junction 16 in interior 18 of pyrolysis furnace 12, and a carbon deposition substrate 28 introduced in interior 18 of pyrolysis furnace 12. While a single heating element 24 is shown in FIG. 3, system 100 may include more than one heating element. In system 100, electrical lead 26 extends from lead junction 16 through thermal barrier 22 to an exterior environment.

System 100 further includes a hydrocarbon inlet 30. In some examples, at least one hydrocarbon (for example, methane) may be introduced into pyrolysis furnace 12 through hydrocarbon inlet 30. Heating element 24 may heat furnace interior 18 to sufficient pyrolysis temperature, for example, at least 1000° C., at least 1200° C., at least 1400° C., at least 1500° C., at least 1800° C., or at least 2000° C. Pyrolysis furnace 12 may pyrolyze the at least one hydrocarbon to produce hydrogen gas, and solid carbon as a byproduct. System 100 may further include a hydrogen outlet 32 configured to discharge hydrogen gas (H₂).

The solid carbon may be generated in the form of soot or dust, and may be received or collected on deposition substrate 28. Deposition substrate 28 may include a fibrous substrate, or any substrate configured to receive and collect deposited carbon (C). Deposition substrate 28 may progressively get loaded with deposited carbon, and eventually be replaced with a fresh unit when a particular unit of deposition substrate 28 reaches complete carbon capacity.

Thus, systems according to the present disclosure may be used to generate hydrogen by hydrocarbon pyrolysis.

The present disclosure describes clamps for securing heating elements, or for coupling heating elements to electrical leads. In some examples, a lead joint includes a clamp. For example, during thermal transients, the lead joint may be subject to forces resulting from thermal expansion, such that clamps described herein may resist such forces and maintain coupling of the heating elements to the electrical leads.

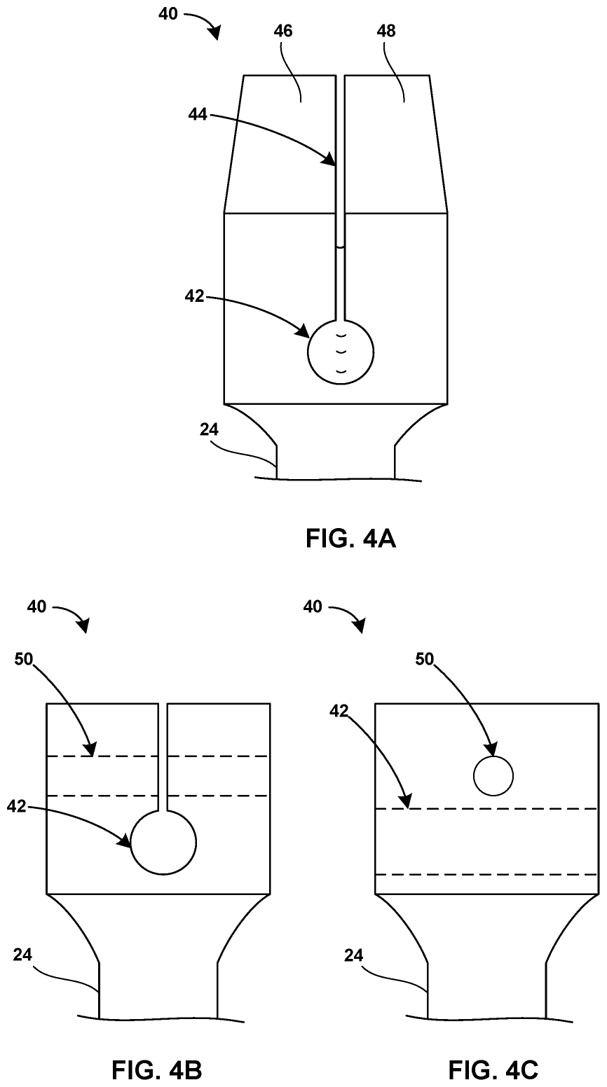

FIG. 4A is a perspective view of a clamp 40 for coupling heating element 24 to an electrical lead (for example, electrical lead 26) for a pyrolysis system. FIG. 4B is a front view of clamp 40 of FIG. 4A. FIG. 4C is a side view of clamp 40 of FIG. 4A. The heating element may be heating element 24, as shown in FIGS. 4A to 4C, or any other heating element. The pyrolysis system may be pyrolysis system 10, 100, or any other pyrolysis system.

Clamp 40 may further secure heating element 24 to a pyrolysis furnace. For example, clamp 40 may secure heating element 24 to a housing of a pyrolysis furnace while coupling heating element 24 to an electrical lead. In some examples, a heating element may be coupled by two clamps to two electrical leads.

Clamp 40 may continuously extend from heating element 24. For example, each end portion of heating element 24 may define a respective clamp. Clamp 40 may include an electrically conductive material. In some examples, clamp 40 includes a metal, an alloy, graphite a ceramic, or combinations thereof. In some examples, clamp 40 includes the same material as heating element 24 and is formed with heating element 24. Clamp 40 may have any suitable shape. In some examples, clamp 40 defines a C-shape, a U-shape, or a D-shape. Clamp 40 may define any suitable exterior surface. In some examples, clamp 40 defines a cuboidal exterior surface.

Clamp 40 defines an expansion bore 42 configured to accommodate or relieve thermal stresses. For example, expansion bore 42 may extend between opposing end faces of clamp 40. Expansion bore 42 may have any suitable cross-section, for example, circular, curved, or polygonal. In some examples, expansion bore 42 has a circular cross-section.

Clamp 40 further defines an expansion slot 44 extending away from bore 42. In some examples, expansion slot 44 extends to a surface between opposing faces through which bore 42 extends. Expansion slot 44 may extend along a linear, curved, or undulating path or path segments. Clamp 40 may include a first leg 46 and a second leg 48 defining expansion slot 44 therebetween. The first leg 46 and second leg 48 may be expand away from each other or contract toward each other in response to thermal strain exhibited by heating element 24.

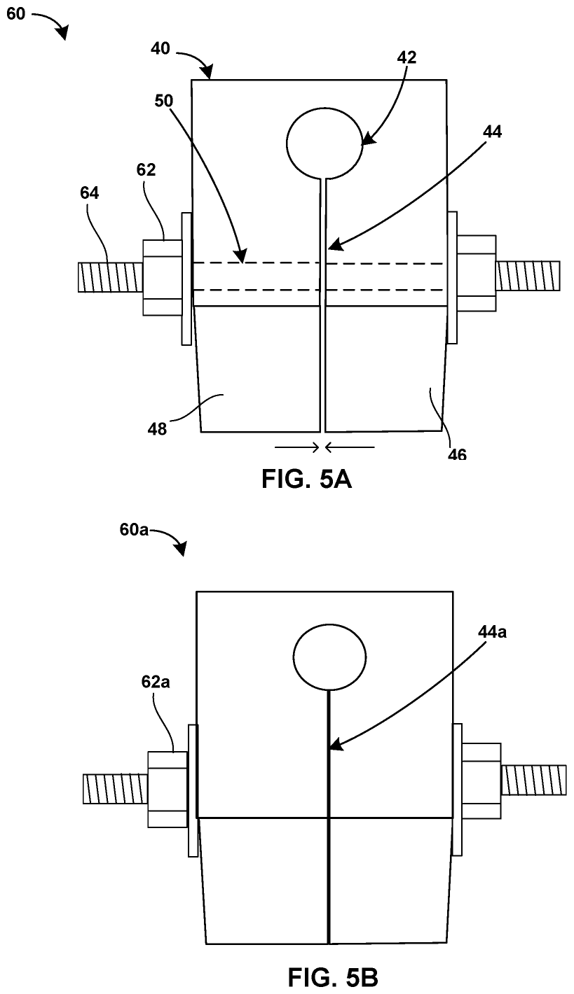

Clamp 40 further defines a channel 50 configured to electrically couple an electrical lead. For example, channel 50 may be configured to receive a shaft, the shaft being electrically coupled to or extending from an electrical lead, and the shaft being configured to receive one or more fasteners. The fastener may be secured to the shaft to across first leg 46 and second leg 48 together, as described with reference to FIGS. 5A and 5B. In some examples, channel 50 is configured to receive a first portion of the threaded shaft to allow a second portion of the threaded shaft to protrude exterior to the clamp.

At elevated temperatures, for example, as a pyrolysis system or a pyrolysis furnace heats to an operating temperature, expansion slot 44 and expansion bore 42 may change shape or dimensions in response to thermal stresses of heating element 24, but while still retaining sufficient electrically conductive coupling between heating element 24 and an electrical lead coupled to heating element 24, for example, through channel 50. Thus, electrical contact is retained via clamp 40 between heating element 24 and a respective electrical lead as the pyrolysis system or pyrolysis furnace is heated to an operating temperature. Clamp 40 may provide a high-temperature resistant elastic connection between heating element 24 and the respective electrical lead. Clamp 40 may also resist loosening of coupling between the heating element and the electrical lead or the housing at high temperatures, for example, via degradation of the heating element.

FIG. 5A is a perspective view of a clamp assembly 60 including nuts 62 coupled to sides of clamp 40 of FIG. 4A in an uncompressed configuration. Clamp assembly 60 further includes a threaded shaft 64. In some examples, one or more nuts 62 are configured to secure the electrical lead between a respective nut and threaded shaft 64.

Threaded shaft 64 may extend through channel 50. In some examples, a single threaded shaft 64 extends through an entirety of channel 50 and extends outward of clamp 40 from opposing ends of channel 50. In other examples, two threaded shafts 64 extend partially into opposed ends of channel 50. In other examples, clamp 40 may define two distinct opposed channels 50 each of which respectively receive a threaded shaft 64. Threaded shaft 60 is configured to couple clamp 40 to one or both of an electrical lead or a housing of a pyrolysis furnace.

FIG. 5B is a perspective view of the clamp assembly of FIG. 5A in a compressed configuration 60a. For example, clamp assembly may move between uncompressed configuration 60 and compressed configuration 60a in response to temperature changes as heating element 24 heats or cools during operation of the pyrolysis furnace (or of a pyrolysis system).

Nuts 62 may include any rigid material, for example, a metal, an alloy, graphite, silicon carbide or a ceramic. In some examples, nuts 62 include a composite matrix, for example, a carbon composite, a boron nitride composite, or a ceramic composite. Nuts including a composite matrix may facilitate ease of repair, and reduce failure modes. Carbon or other composites may exhibit frictional properties amenable to hand-tightening of nuts 62, which may reduce or avoid the need for tools for tightening, loosening, or repairing nuts 62 or otherwise any system including nuts 62. In some examples, anisotropy in composite matrix may be used to reduce or prevent overtightening of nuts 62 or stripping of threads in nuts 62. For example, overtightening nuts 62 may induce nuts 62 to visibly split, indicating an occurrence of overtightening. Nuts 62 may include one or more layers of composite, for example, stacked layers of composite matrix. Edges of nuts 62 may be beveled.

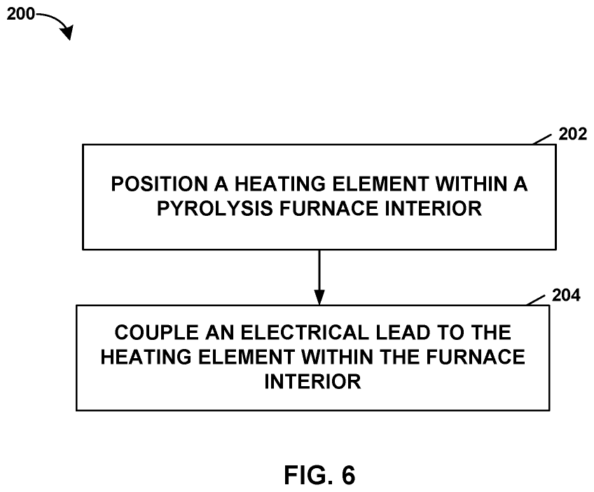

FIG. 6 is a flowchart representing a technique 200 for forming a pyrolysis system configured to generate hydrogen gas by hydrocarbon pyrolysis. Technique 200 may be used to assembly pyrolysis system 10, 100, or any other system according to the present disclosure. In other examples, any other suitable technique may be used to assembly pyrolysis systems according to the present disclosure.

Technique 200 may include positioning a heating element within a furnace interior of a pyrolysis furnace including a chamber including a thermal barrier (202). Technique 200 may further include coupling an electrical lead to the heating element at a lead junction within the furnace interior (204). The electrical lead may include a refractory material. A maximum cross-sectional area of the electrical lead may be less than a minimum cross-sectional Joule area of the heating element.

The following clauses illustrate example subject matter described herein.

Clause 1: A pyrolysis system for generating hydrogen gas by hydrocarbon pyrolysis, the system including: a pyrolysis furnace including a chamber defining a furnace interior, the chamber including a thermal barrier; and a heating system including a heating element coupled to an electrical lead at a lead junction, where the lead junction is within the furnace interior, where the electrical lead includes a refractory material, and where a maximum cross-sectional area of the electrical lead is less than a minimum cross-sectional Joule area of the heating element.

Clause 2: The system of clause 1, where the electrical lead extends from the lead junction through the thermal barrier to an exterior environment.

Clause 3: The system of any of clauses 1 or 2, where the maximum cross-sectional area of the electrical lead is 10% or less of the minimum cross-sectional Joule area of the heating element.

Clause 4: The system of any of clauses 1 to 3, where the refractory material includes a high electrical conductivity material.

Clause 5: The system of any of clauses 1 to 4, where the refractory material has an electrical conductivity that is at least 1000% of an electrical conductivity of the heating element.

Clause 6: The system of any of clauses 1 to 5, where the lead junction includes a weld or a braze.

Clause 7: The system of any of clauses 1 to 6, where the lead junction includes one or more of a nut, a threaded shaft, a bolt, or a press-fit connection configured to provide a conductive path between the electrical lead and the heating element.

Clause 8: The system of any of clauses 1 to 7, where an end of the heating element is coupled to the electrical lead at the lead junction.

Clause 9: The system of any of clauses 1 to 8, where the electrical lead is a first electrical lead, where the lead junction is a first lead junction, the system further including a second electrical lead coupled to the heating element at a second lead junction.

Clause 10: The system of clause 9, where the first lead junction couples a first end of the heating element, and where the second lead junction couples a second end of the heating element.

Clause 11: The system of any of clauses 1 to 10, where the lead junction includes a clamp, where the clamp defines an expansion bore and an expansion slot extending away from the expansion bore, the expansion slot and the expansion bore configured to relieve thermal stresses experienced by the heating element.

Clause 12: The system of clause 11, where the expansion slot extends from the expansion bore to a surface of the clamp.

Clause 13: The system of any of clauses 11 or 2, where the clamp defines a cuboidal exterior surface.

Clause 14: The system of any of clauses 11 to 13, where the clamp includes an electrically conductive material.

Clause 15: The system of any of clauses 11 to 14, where the clamp further includes a threaded shaft configured to couple the electrical lead to the clamp.

Clause 16: The system of clause 15, where the clamp defines a channel configured to receive a first portion of the threaded shaft to allow a second portion of the threaded shaft to protrude exterior to the clamp.

Clause 17: The system of clause 16, where the clamp further includes a nut securing the electrical lead between the nut and the threaded shaft.

Clause 18: The system of clause 17, where the nut includes a metal or an alloy.

Clause 19: The system of any of clauses 17 or 18, where the nut includes a carbon composite matrix.

Clause 20: A method for assembling a system configured to generate hydrogen gas by hydrocarbon pyrolysis, the method including: positioning a heating element within a furnace interior of a pyrolysis furnace including a chamber including a thermal barrier; and coupling an electrical lead to the heating element at a lead junction within the furnace interior, where the electrical lead includes a refractory material, and where a maximum cross-sectional area of the electrical lead is less than a minimum cross-sectional Joule area of the heating element.

Clause 21: A clamp configured to secure a heating element for a pyrolysis furnace, the clamp defining an expansion bore and an expansion slot extending away from the expansion bore, the expansion slot and the expansion bore configured to relieve thermal stresses experienced by the heating element.

Various examples have been described. These and other examples are within the scope of the following claims.

What is claimed is:

1. A pyrolysis system for generating hydrogen gas by hydrocarbon pyrolysis, the system comprising:
a pyrolysis furnace comprising a chamber defining a furnace interior, the chamber comprising a thermal barrier; and
a heating system comprising a heating element coupled to an electrical lead at a lead junction,
wherein the lead junction is within the furnace interior,
wherein the electrical lead comprises a refractory material, and
wherein a maximum cross-sectional area of the electrical lead is less than a minimum cross-sectional Joule area of the heating element.

2. The system of claim 1, wherein the electrical lead extends from the lead junction through the thermal barrier to an exterior environment.

3. The system of claim 1, wherein the maximum cross-sectional area of the electrical lead is 10% or less of the minimum cross-sectional Joule area of the heating element.

4. The system of claim 1, wherein the refractory material comprises a high electrical conductivity material.

5. The system of claim 1, wherein the refractory material has an electrical conductivity that is at least 1000% of an electrical conductivity of the heating element.

6. The system of claim 1, wherein the lead junction comprises a weld or a braze.

7. The system of claim 1, wherein the lead junction comprises one or more of a nut, a threaded shaft, a bolt, or a press-fit connection configured to provide a conductive path between the electrical lead and the heating element.

8. The system of claim 1, wherein an end of the heating element is coupled to the electrical lead at the lead junction.

9. The system of claim 1, wherein the electrical lead is a first electrical lead, wherein the lead junction is a first lead junction, the system further comprising a second electrical lead coupled to the heating element at a second lead junction.

10. The system of claim 9, wherein the first lead junction couples a first end of the heating element, and wherein the second lead junction couples a second end of the heating element.

11. The system of claim 1, wherein the lead junction comprises a clamp, wherein the clamp defines an expansion bore and an expansion slot extending away from the expansion bore, the expansion slot and the expansion bore configured to relieve thermal stresses experienced by the heating element.

12. The system of claim 11, wherein the expansion slot extends from the expansion bore to a surface of the clamp.

13. The system of claim 11, wherein the clamp defines a cuboidal exterior surface.

14. The system of claim 11, wherein the clamp comprises an electrically conductive material.

15. The system of claim 11, wherein the clamp further comprises a threaded shaft configured to couple the electrical lead to the clamp.

16. The system of claim 15, wherein the clamp defines a channel configured to receive a first portion of the threaded shaft to allow a second portion of the threaded shaft to protrude exterior to the clamp.

17. The system of claim 16, wherein the clamp further comprises a nut securing the electrical lead between the nut and the threaded shaft.

18. The system of claim 17, wherein the nut comprises a metal or an alloy.

19. The system of claim 17, wherein the nut comprises a carbon composite matrix.

20. A method for assembling a system configured to generate hydrogen gas by hydrocarbon pyrolysis, the method comprising:
positioning a heating element within a furnace interior of a pyrolysis furnace comprising a chamber comprising a thermal barrier; and
coupling an electrical lead to the heating element at a lead junction within the furnace interior,
wherein the electrical lead comprises a refractory material, and
wherein a maximum cross-sectional area of the electrical lead is less than a minimum cross-sectional Joule area of the heating element.
